(19) United States
(12) Patent Application Publication
(10) Pub. No.: US 2004/0091663 A1
(43) Pub. Date: May 13, 2004

(54) Loess fomentation mask

(76) Inventor: Jong-Hyeon Jang, Seoul (KR)

Correspondence Address: Richard M. Goldberg, Suite 419, 25 East Salem Street, Hackensack, NJ, 07601, US

(21) Appl. No.: 10/340,305

(22) Filed: Jan. 10, 2003

(30) Foreign Application Priority Data
Nov. 7, 2002 (KR) 2002-68719

(51) Int. Cl. B32B 3/10

(52) U.S. Cl. 428/68; 428/138

(57) ABSTRACT

A loess fomentation pack includes a pocket formed between a synthetic resin film sheet and a first non-woven fabric adhered along circumferences thereof, heat generating materials comprising iron powder, salt, and activated carbon which are introduced into the pocket, a synthetic resin coating sheet to be attached to the non-woven fabric, a loess plate made by mixing loess, water and a vegetable adhesive, and a second non-woven fabric having one side adhered to the loess plate and an opposite side adhered with the synthetic resin film sheet.

### BACKGROUND OF THE INVENTION

The present invention relates to a loess fomentation pack. More particularly, the present invention relates to a loess fomentation pack comprising a pocket formed by adhering a synthetic resin film sheet and a non-woven fabric along their circumference, heat generating materials comprising iron powder, salt, an activated carbon which are introduced into the pocket, a synthetic resin coating sheet to be attached to the non-woven fabric, a loess plate made by mixing loess, water and a vegetable adhesive (non-toxic adhesive), and another non-woven fabric of which one side is adhered to said loess plate and the other side is glued with said synthetic resin film sheet. The heat generating materials introduce into the pocket generate heat and thereby the loess plate is heated. Far infrared rays from the heated loess plate are adsorbed into the skin to provide self-heat generation. The loess fomentation pack of the present invention can thus have functions of activating cells, accelerating blood-circulation and facilitating metabolism. Accordingly, the loess fomentation pack of the present invention provides an effect of curing skin diseases as well as a cosmetic effect.

Generally, a face massage has been done by attaching sliced fruits or vegetables, or juice thereof on the face. Such massage method takes time for preparing massage materials and cannot provide a sufficient effect on the face care. When a hot fomentation is required on the face, a hot towel has been applied on the face. Otherwise, a water bag made of a synthetic resin or a rubber material is heated and put on the face. However, these methods are neither convenient nor effective in the face massage.

Recently, a fomentation pack has been used in which germanium or jade are contained. Since this pack is heated by using an electric heater or putting it into hot water, it cannot be conveniently used. Also, a loess fomentation pack has been used in which loess powder is mixed with water and applied on the face. Such pack also takes time for preparation, makes the face dirty and merely makes the face soft. Thus, there is a need for an article which is more effective in the face massage and can be conveniently used.

### SUMMARY OF THE INVENTION

The present invention was designed to solve the aforementioned problems.

An object of the present invention is to provide a pack which can be conveniently used, and can provide effects of activating cells, accelerating blood-circulation and facilitating metabolism.

In order to attain the above objects, the present invention provides a loess fomentation pack which comprises a pocket formed by adhering a synthetic resin film sheet and a non-woven fabric along their circumference, heat generating materials comprising iron powder, salt, activated carbon which are introduced into the pocket, a synthetic resin coating sheet to be attached to the non-woven fabric, a loess plate made by mixing loess, water and a vegetable adhesive (non-toxic adhesive), and another non-woven fabric of which one side is adhered to said loess plate and the other side is glued with said synthetic resin film sheet.

When using the loess fomentation pack according to the present invention, a synthetic resin coating sheet is first removed and a pocket is shaken to allow heat generating materials to be mixed well with air for about 1 to 2 min. By shaking, heat generating materials start to generate heat slowly. If a loess plate is stuck to the pocket and they are placed on the face, heat from the heat generating materials is transmitted to the loess plate and the heated loess plate in turn generates far infrared rays. The far infrared rays are absorbed into the skin and provide a self-heat generation phenomenon. Through such phenomenon, body components are activated and thereby, blood circulation is accelerated and metabolism is facilitated. Therefore, the loess fomentation pack of the present invention provides the aforementioned skin care effect as well as the effect of curing skin diseases.

### BRIEF DESCRIPTION OF THE DRAWINGS

Other objects and features of the present invention will be hereinafter explained in detail with reference to the accompanying drawings, wherein:

FIG. 1 is an exploded perspective view of a loess fomentation pack of the present invention.

FIG. 2 is a combined perspective view of a loess fomentation pack of the present invention.

FIG. 3 is a rear perspective view of a loess fomentation pack of the present invention.

FIG. 4 is an enlarged cross-sectional view of a loess fomentation pack of the present invention.

FIG. 5 is an illustrated view showing a state of using a loess fomentation pack of the present invention.

FIG. 6 is a front view showing a state of a loess fomentation pack as packed in the box.

FIG. 7 is an exploded perspective view of another loess fomentation pack of the present invention.

FIG. 8 is a combined perspective view of the other loess fomentation pack as shown in FIG. 7.

FIG. 9 is an enlarged cross-sectional view of the other loess fomentation pack as shown in FIG. 7.

FIG. 10 is an illustrated view showing a state of using the loess fomentation pack as shown in FIG. 7.

FIG. 11 is an exploded perspective view of another loess fomentation pack of the present invention.

FIG. 12 is a combined perspective view of the loess plate as shown in FIG. 11.

FIG. 13 is an enlarged cross-sectional view of the loess plate as shown in FIG. 11.

FIG. 14 is an illustrated view showing a state of using another loess fomentation pack of the present invention, which is covered and fixed by an adhesive fabric.

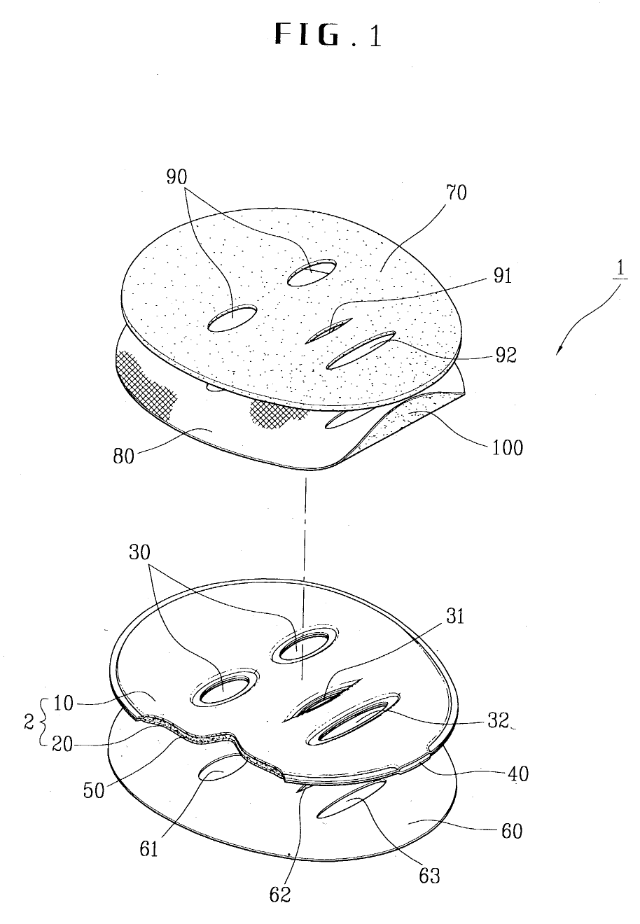

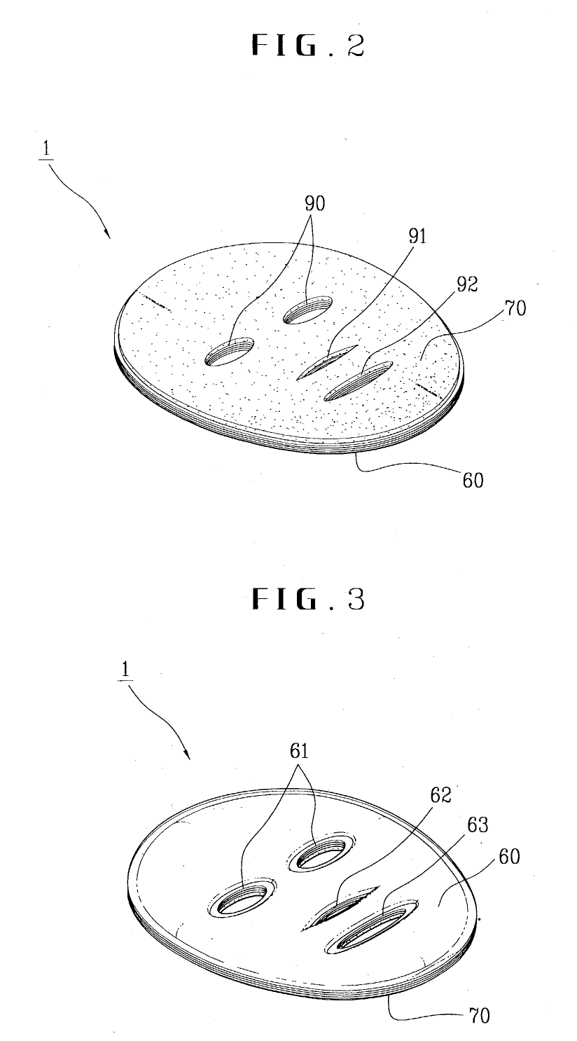

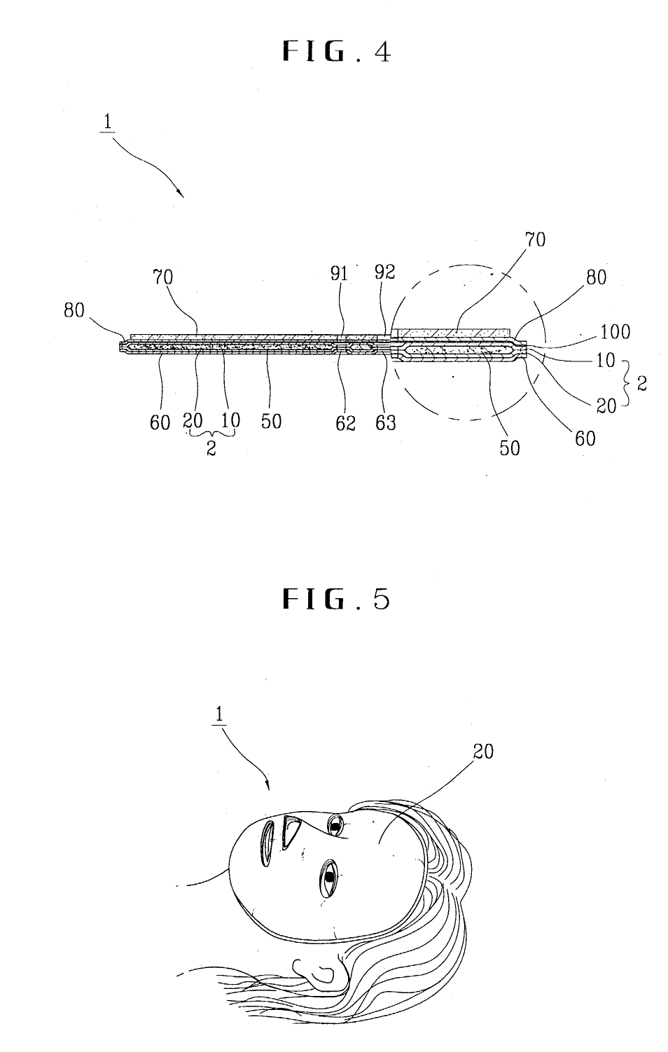

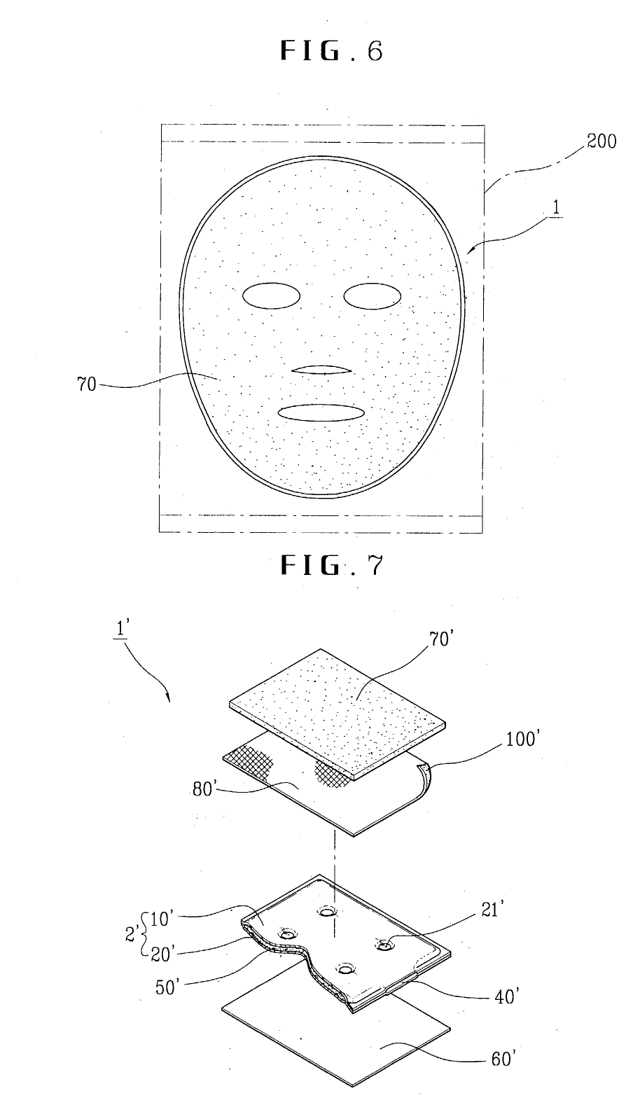

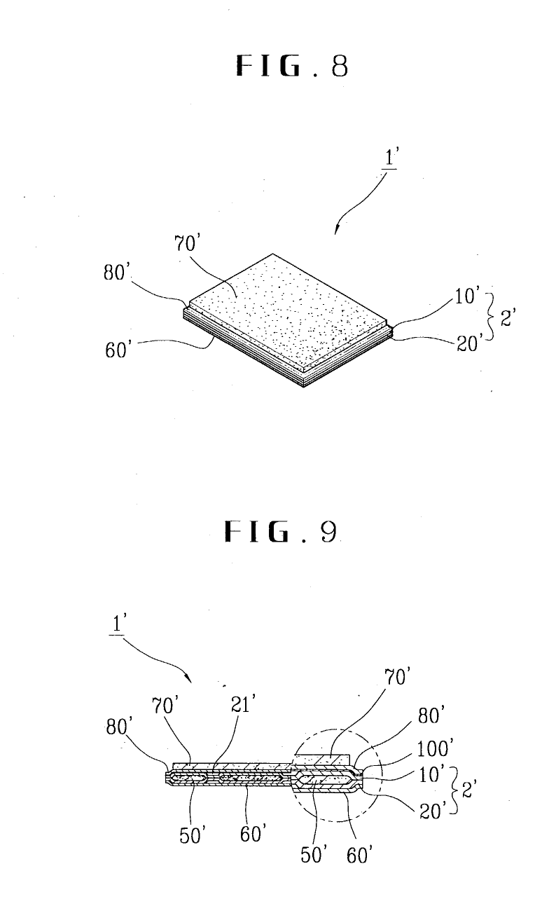

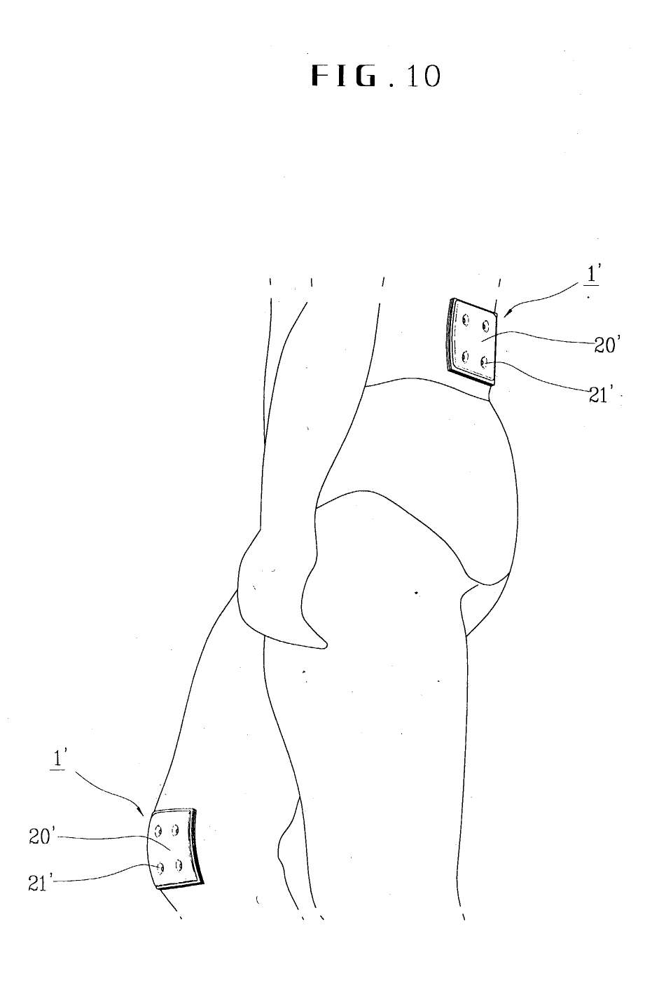

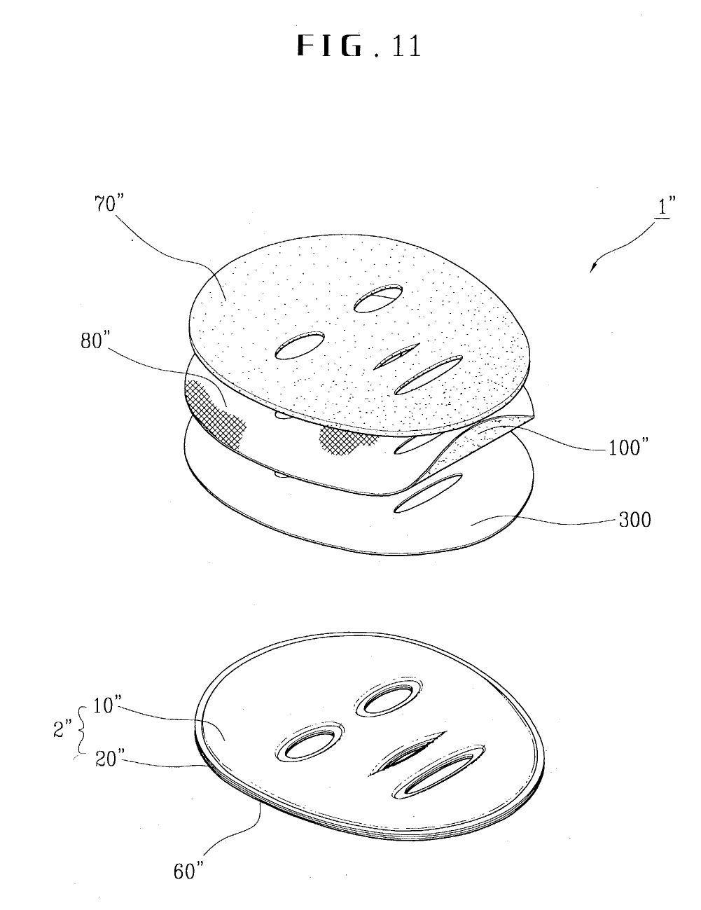

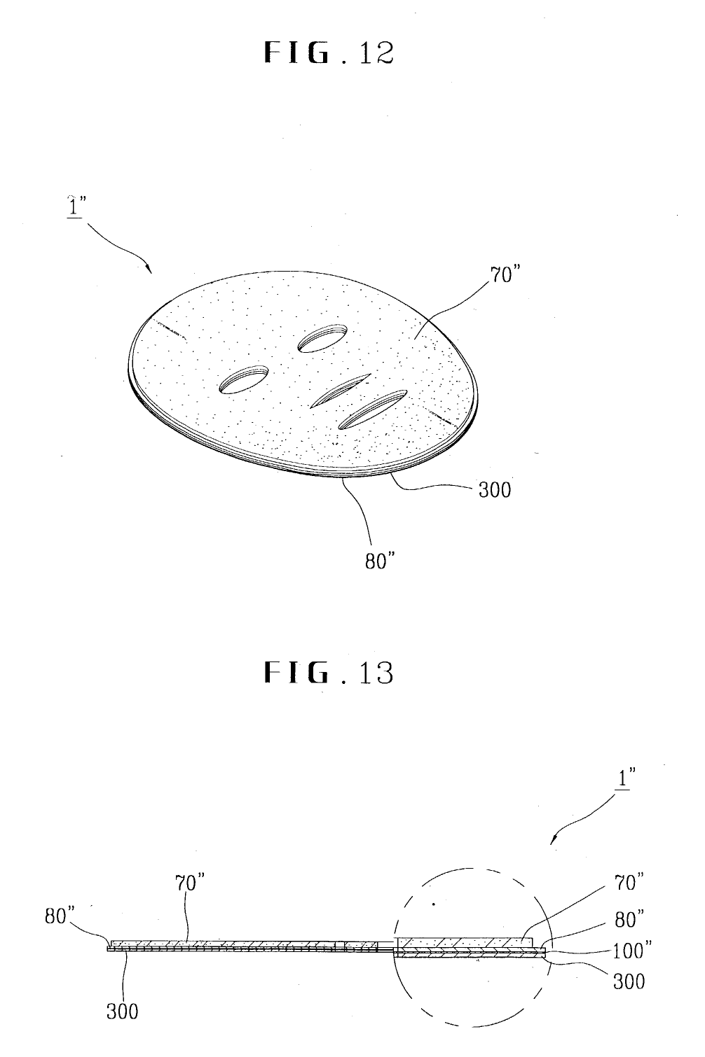

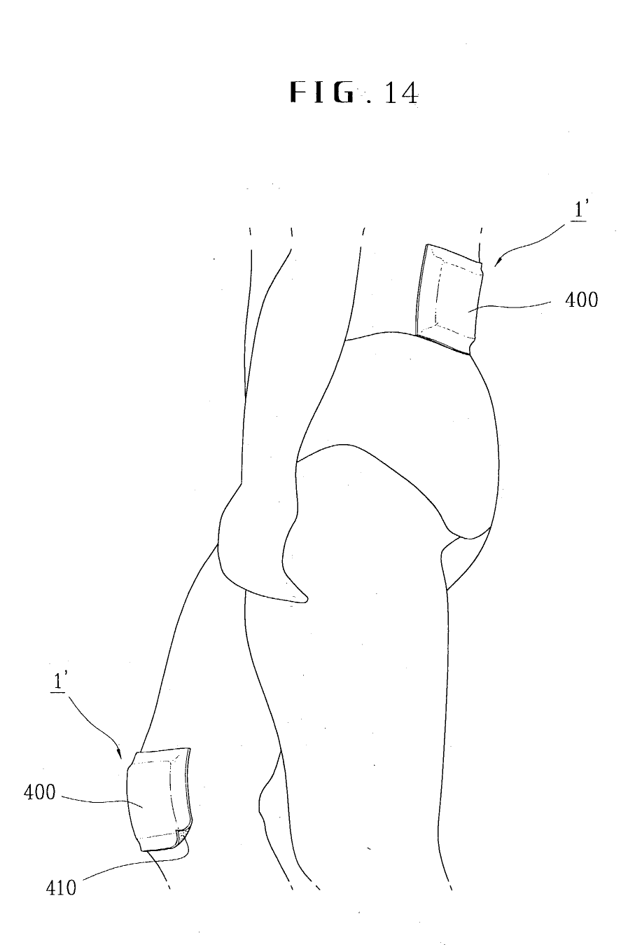

### DESCRIPTION OF THE PREFERRED EMBODIMENTS

The present invention is related to a loess fomentation pack which comprises a pocket 2 formed by adhering a synthetic resin film sheet 10 and a non-woven fabric 20 along their circumference, which contains holes for eyes 30, nose 31 and mouth 32, heat generating materials 50 comprising iron powder, salt, activated carbon which are introduced into the pocket, a synthetic resin coating sheet 60 which has holes for eyes 61, nose 62 and mouth 63 and is to be attached to the non-woven fabric 20, a loess plate 70 which is made by mixing loess, water and a vegetable adhesive (non-toxic adhesive) and puncturing holes for eyes 90, nose 91 and mouth 92, and another non-woven fabric 80 of which one side is adhered to said loess plate and the other side is glued with said synthetic resin film sheet.

Numeral 200 indicates a box.

A loess fomentation pack of the present invention is manufactured by adhering a round shape synthetic resin film sheet 10 and a non-woven fabric 20 along the circumference to form a pocket 2 and to make an inlet 40, making holes for eyes 30, nose 31 and mouth 32 on the pocket and adhering around the holes, introducing a predetermined amount of heat generating materials 50 consisting of a highly pure iron powder, salt, an activated carbon into the pocket 2 through the inlet 40, adhering a synthetic resin coating sheet 60 having holes for eyes 61, nose 62 and mouth 63 to the nonwoven fabric 20 to avoid penetrating air into the pocket 2 and to close the inlet 40, gluing a round loess plate 70 with holes for eyes 90, nose 91 and mouth 92 made by mixing loess, water and a vegetable adhesive to a round nonwoven fabric 80, and adhering the nonwoven fabric 80 on which adhesive 100 is applied on one side to the synthetic resin film sheet 10. The loess fomentation pack 1 is stored in a box 200 and sold in that way.

The loess fomentation pack 1 is used by stripping a coating film sheet 60 adhered to nonwoven fabric 20, shaking the loess fomentation pack 1 and then putting the warmed loess plate 70 on the face as shown in FIG. 5. Since the nonwoven fabric 20 is air-permeable, heat generating materials 50, which are introduced into the pocket formed by adhering a synthetic resin film sheet 10 and nonwoven fabric 20, are mixed with air and start to generate heat, by shaking the loess fomentation pack 1. The heat is transmitted to the loess plate 70 and the loess plate 70 heats over time. The heated loess plate 70 starts to generate far infrared rays. The main component of the loess plate 70 is germanium, which generates far infrared rays, and minor components thereof are catalase, diphenol, oxidase, saccharase, protease, etc. A spoonful of loess contains 220 kinds of 0.2 billion microorganisms. Such loess emits lots of far infrared rays which are effectively adsorbed by organic compounds having 4-5μ wavelength and have a feature of self-heat generation. If the skin is exposed to far infrared rays of the loess, far infrared rays are deeply penetrated into the body to raise the body temperature and to accelerate metabolism. This in turn brings cell activation and facilitates blood circulation. It has been thus known that loess has functions of preventing lumbago, neuralgia, arthritis, etc., eliminating waste matter from the body, curing hypertension and hypotension effectively by improving the blood stream, and promoting hepatic and kidney functions through blood purification.

The temperature of heat generating materials 50 is able to be controlled by the amount of the heat generating materials to be introduced into the pocket 2. The temperature is generally in the range from about 50° C. to about 67° C. and maintained for about 10 hours. Heat transmitted to the face through the loess plate is about 40° C. The fomentation is preferably carried out for about 20 to 30 min. and the pack is detached from the face. Otherwise, several persons can take fomentation by using the heated loess plate 70 for 20 mins. by turns.

FIG. 7 shows another embodiment of a loess fomentation pack 1′ according to the present invention which comprises a pocket 2′ formed by adhering a rectangular shape of synthetic resin film sheet 10′ and nonwoven fabric 20′ along their outer circumferences, which have several adhered sites 21′ and an inlet 40′, heat generating materials 50′ consisting of highly pure iron powder, salt, activated carbon which are introduced into the pocket via the inlet 40′, a synthetic resin coating sheet 60′ to be attached to the non-woven fabric 20′, a loess plate 70′ made by mixing loess, water and a vegetable adhesive (non-toxic adhesive), and another non-woven fabric 80′ of which one side is adhered to said loess plate 70′ and the other side on which adhesive 100′ is applied is glued with said synthetic resin film sheet 10′.

This loess fomentation pack 1′ is attached to a painful part or fomentation part such as a lumbago or arthritic part. Due to several adhered sites 21′, heat generating materials 50′ are evenly distributed over the pocket 2′. The loess fomentation pack 1′ is used by stripping a synthetic resin coating sheet 60′ adhered to one side of the pocket 2′, shaking the pocket 2′ and then putting it with the warmed loess plate 70′. By shaking or rubbing, heat generating material 50′ is mixed with air and starts to generate heat. The heat is transmitted to the loess plate 70′ and the loess plate 70 is heated. The heated loess plate 70′ starts to generate far infrared rays. Thus, the loess fomentation pack 1′ has functions of curing various diseases and providing fomentation for a long time.

FIG. 11 shows another embodiment of a loess fomentation pack 1″ according to the present invention which comprises a pocket 2″ formed by adhering a synthetic resin film sheet 10″ and nonwoven fabric 20″ along their outer circumferences, heat generating materials 50″ introduced into pocket 2″, a synthetic resin coating sheet 60″ to be attached to non-woven fabric 20″ along its circumference, a loess plate 70″, and another non-woven fabric 80″ of which one side is adhered to said loess plate 70″ and the other side on which adhesive 100″ is applied is glued with release paper 300. When a loess plate 70″ is too dry to use or several people want to have fomentation together, the loess plate 70″ can be simply replaced with a new one by stripping a release paper. That is, nonwoven fabric 80″ and a release paper 300 are stripped from the loess plate 70″ and the loess plate is glued to synthetic resin film sheet 10″ of the pocket 2″. FIG. 14 shows a state of using a loess fomentation pack 1′ according to the present invention at a painful part or fomentation part. As illustrated in FIG. 14, an adhesive fabric 400 can be used in order to secure loess fomentation pack even while moving.

In another embodiment of the present invention, clay may be used in the fomentation pack instead of loess.

As mentioned above, a loess fomentation pack 1 according to the present invention generates far infrared rays and far infrared rays are adsorbed into the body to provide self-heat generation. The self-heat generation results in activating cells, accelerating blood-circulation and facilitating metabolism. Accordingly, the loess fomentation pack of the present invention provides an effect of curing skin diseases as well as a cosmetic effect. The loess fomentation pack can be also used easily and conveniently by stripping a synthetic resin coating sheet 60 attached to one side of pocket 2, shaking pocket 2 and putting the loess fomentation pack on the face. As illustrated in FIG. 7, the loess fomentation pack 1′ of the present invention can be made in a rectangular shape and be used on a painful part or fomentation part such as a lumbago or arthritic part, rather than the face. By shaking or rubbing the loess fomentation pack, heat generating materials 50 are mixed with air and start to generate heat. Due to the heat, the loess plate 70′ is heated and the heated loess plate 70′ starts to generate far infrared rays. Thus, the loess fomentation pack provides an effect of curing various diseases as well as a fomentation effect for a long time. As shown in FIG. 11, a loess plate 70″ can be readily replaced with new one by stripping a release paper when several people want to make fomentation together.

What is claimed is:

1. A loess fomentation pack comprising:
a pocket formed between a synthetic resin film sheet and a first non-woven fabric adhered along circumferences thereof,
heat generating materials comprising iron powder, salt, and activated carbon which are introduced into the pocket,
a synthetic resin coating sheet to be attached to said non-woven fabric,
a loess plate made by mixing loess, water and a vegetable adhesive, and
a second non-woven fabric having one side adhered to said loess plate and an opposite side adhered with said synthetic resin film sheet.

2. A loess fomentation pack according to claim 1, wherein said synthetic resin film sheet, first non-woven fabric, synthetic resin coating sheet and loess plate are all in a shape of a face and have holes for eyes, nose and mouth, and said synthetic resin film sheet and first non-woven fabric forming said pocket are also adhered along circumferences of the holes.

3. A loess fomentation pack according to claim 1, wherein said synthetic resin film sheet, first non-woven fabric, synthetic resin coating sheet and loess plate each have a rectangular shape.

4. A loess fomentation pack according to anyone of claim 1, further comprising an adhesive fabric for securing the loess fomentation pack to a painful part or fomentation part of a body.

5. A fomentation pack comprising:
a pocket formed between a synthetic resin film sheet and a first non-woven fabric adhered along circumferences thereof,
heat generating materials comprising iron powder, salt, and activated carbon which are introduced into the pocket,
a synthetic resin coating sheet to be attached to said non-woven fabric,
a clay plate, and
a second non-woven fabric having one side adhered to said loess plate and an opposite side adhered with said synthetic resin film sheet.

6. A loess fomentation pack comprising:
a pocket formed between a synthetic resin film sheet and a first non-woven fabric adhered along circumferences thereof,
heat generating materials introduced into the pocket,
a synthetic resin coating sheet to be attached to said non-woven fabric,
a loess plate, and
a second non-woven fabric having one side adhered to said loess plate and an opposite side adhered with said synthetic resin film sheet.

7. A loess fomentation pack according to claim 6, wherein said heat generating materials comprise iron powder, salt, and activated carbon.

8. A loess fomentation pack according to claim 6, wherein said loess plate is made by mixing loess, water and a vegetable adhesive
